(19) United States
(12) Patent Application Publication
(10) Pub. No.: US 2025/0363885 A1
(43) Pub. Date: Nov. 27, 2025

(54) METHODS AND SYSTEMS FOR WEARABLE ASSISTIVE TECHNOLOGY

(71) Applicant: Kessler Foundation Inc., Newark, NJ (US)

(72) Inventors: Peii Chen, New York, NY (US); Kiran Karunakaran, Newark, NJ (US)

(21) Appl. No.: 19/208,095

(22) Filed: May 14, 2025

Related U.S. Application Data
(60) Provisional application No. 63/650,643, filed on May 22, 2024.

(51) Int. Cl. G08B 25/01; G02B 27/01; G08B 7/06; G08B 21/02

(52) U.S. Cl. CPC G08B 25/016; G02B 27/0101; G02B 27/017; G08B 7/06; G08B 21/02; G02B 2027/0138; G02B 2027/0141

(57) ABSTRACT

Wearable system for providing hazard alerts to a wearer while moving within an environment incudes a processor coupled to a HMD and a plurality of sensors disposed proximate the HMD. The HMD having a display enables the wearer to view a region of their environment in the direction of their gaze through or rendered on the display. The sensor generate depth image signals indicative of a distance from the sensor to a point in the environment. The processor is configured to create disparity map data based on the depth image signals; process such data to identify potential objects in the path of the wearer that may pose a potential hazard risk; determine a distance of one of the potential objects to evaluate whether such distance is within a hazard distance to the wearer; and transmit hazard signals to the HMD to generate a hazard alert to the wearer.

### CROSS-REFERENCE TO RELATED APPLICATION

This U.S. Non-Provisional patent application claims priority under 35 U.S.C. § 119(e) to U.S. Provisional Patent Application No. 63/650,643, entitled “METHODS AND SYSTEMS FOR WEARABLE ASSISTIVE TECHNOLOGY,” filed on May 22, 2024, which is incorporated by reference herein in its entirety.

### FIELD OF THE INVENTION

This patent specification generally relates to the field of wearable assistive technology, and more specifically, to computer-implemented methods and systems for wearable assistive technology for providing hazard alerts to wearers that pose fall risks while moving within an environment.

All publications and other references cited in this application are incorporated herein by reference in their entirety for all purposes and to the same extent as if each individual publication or other reference was specifically and individually indicated to be incorporated by reference in its entirety for all purposes. Citation of a reference herein shall not be construed as an admission that such is prior art to the present invention.

### BACKGROUND

Each year, about $50 billion is spent on medical costs related to non-fatal fall injuries as reported by the Centers for Disease Control and Prevention at www.cdc.gov/falls/data-research/?CDC_AAref_Val=https://www.cdc.gov/falls/data/index.html, which is referred to herein as the “CDC Falls Data Report”, referencing Florence, C. S., Bergen, G., Atherly, A., Burns, E., Stevens, J., & Drake, C. (2018). Medical Costs of Fatal and Nonfatal Falls in Older Adults. Journal of the American Geriatrics Society, 66(4), 693-698, available at www.doi.org/10.1111/jgs.15304). Falls most frequently occur in indoor settings such as homes and hospitals. It has been reported that six out of 10 falls are at home, where people spend much of their time, and tend to move around without thinking about their safety. Similarly, the biggest safety concern in hospitals is the risk of falls among patients who are able to walk or recently regained the ability to walk. In-hospital falls result in significant physical and economic burdens to patients including increased injury and mortality rates, and decreased quality of life, as well as to medical organizations in the form of at least increased lengths of stay, medical care costs, and litigation).

Navigation involves motor planning, i.e., planning of the movement, being able to pay attention to the environment, assimilate and process the information, and react effectively to produce efficient movement, avoid obstacles, and prevent a fall. Older adults and people with neurological disorders or physical disabilities after a brain injury, such as, for example, stroke and head trauma, often have impaired cognitive and motor functions that impede their mobility, such as insufficient allocation of spatial attention, reduced processing speed, inefficient gait patterns, and impaired balance mechanisms. The decreased control and coordination prevent effective home/community navigation and leads to falls.

Safety is often more compromised in circumstances that require focus on a secondary task such as talking, etc. About a quarter of people over the age of 65 experience at least one fall accident per year as reported by the CDC Falls Data Report, referencing Kakara, R., Bergen, G., Burns, E., & Stevens, M. (2023). Nonfatal and Fatal Falls Among Adults Aged >/=65 Years—United States, 2020-2021. MMWR; Morbidity and Mortality Weekly Report, 72(35), 938-943, available at www.doi.org/10.15585/mmwr.mm7235a1. Further, the rate of falls and severity of the resulting complications increase dramatically with age. This is a significant problem as the U.S. population is aging. By 2030, it is estimated that 1 out of every 5 Americans will be a member of the elderly population.

In addition to cognitive and physical impairment, fear of falling also contributes to the increase of fall risks. Fear of falling is a lasting concern about falling that can lead an individual to avoid activities that they are able to perform, contributing to decreased mobility and increased isolation. It is a serious and common problem among aging adults and brain injury survivors including, for example, survivors of stroke and head trauma, which include more than 54 million people in the U.S. That is, the problem of compromised abilities to process and react to spatial information is prevalent and impactful. Existing assistive technology (AT) can reduce the risk of falls, improve safety, and may also alleviate the fear of falling. However, there are significant limitations in current AT.

Current AT is focused on walking aids and fall alarms. Walking aids can provide the extra support (e.g., balance) needed to walk safely. Canes may provide enough support for some people, but others may need a walker or rollator, i.e., a rolling walker with a seat. A walker has four legs, and all four legs stay in contact with the ground when the user is moving. The walker must be lifted in order to move forward. A rollator has four wheels and brakes and does not need to be lifted to move forward.

Fall alarms can alert others that a person has fallen and needs help, or a person may fall and needs to be monitored when, for example, trying to get out of bed. Some alarm sensors are attached to furniture, and others are wearables that sense changes in the person's position. In hospital settings, much has been invested in techniques, such as colored wrist band to notify hospital staff of patients with high fall risks, and technologies, for example, near-fall detectors, 24/7 surveillance cameras installed in patients' rooms. However, based on the latest Cochrane review provide in Cameron, I. D., Dyer, S. M., Panagoda, C. E., Murray, G. R., Hill, K. D., Cumming, R. G., & Kerse, N. (2018). Interventions for preventing falls in older people in care facilities and hospitals. Cochrane Database of Systematic Reviews, 9, CD005465, available at www.doi.org/10.1002/14651858.CD005465.pub4, and scoping review in Cooper, K., Pavlova, A., Greig, L., Swinton, P., Kirkpatrick, P., Mitchelhill, F., Simpson, S., Stephen, A., & Alexander, L. (2021). Health technologies for the prevention and detection of falls in adult hospital inpatients: A scoping review. JBI Evidence Synthesis, 19(10), 2478-2658, available at www.doi.org/10.11124/JBIES-20-00114, there is no method that effectively prevent falls in healthcare facilities or hospital settings. Research on home-based AT for fall prevention is even more scarce.

Presently, safety systems designed and available for a car—to warn or assist drivers to avoid imminent collisions and reduce the risk of incidents using a variety of technologies and sensors—are better than those available to a person. There is extensive research focused on the use of various sensor technologies (such as cameras, LiDAR, and ultrasonic sensors) to detect obstacles and help with the navigation of cars, unmanned aerial vehicles, etc. Research on obstacle detection is severely lacking for human navigation and has been focused on assistance for people with blindness or visual impairment as reported in, for example, Guerrero, L. A., Vasquez, F., & Ochoa, S. F. (2012). An indoor navigation system for the visually impaired. Sensors, 12(6), 8236-8258, available at www.doi.org/10.3390/s120608236, and Rahman, S., Ullah, S., & Ullah, S. (2018). Obstacle detection in indoor environment for visually impaired using mobile camera. Journal of Physics: Conference Series (960), 012046, available at www.doi.org/10.1088/1742-6596/960/1/012046. However, these technologies have pre-loaded schematics of the environment and do not provide precise real-time information about the obstacles to adjust users' ambulation strategy, which at minimum, aims to avoid obstacles at an average community ambulation speed.

While there are many commercially available AT products, there is a lack of safety systems that consider the dynamic changes between the user and the environment as the user is moving. User factors, such as speed, changing directions, environment factors, such as objects, lighting, surface texture, and the relative factors between the two including, the distance between the user and an object, can play determinant roles in safety concern.

Thus, there is a significant need for person-centered AT to reduce fall risks and improve safety for individuals who are not visually impaired but definitely in need for assistance, especially older adults and people with neurological disorders or physical disabilities after a brain injury.

### BRIEF SUMMARY OF THE INVENTION

The invention described herein overcomes the above-described difficulties and short comings of presently available personal AT systems by providing an AT system for everyday use having personalized navigation at home or in hospitals that alerts users, i.e., wearers of the AT systems, of potential obstacles in their path of travel. As used herein, the terms “user” and “wearer” in plural and singular form are used interchangeably, and are intended to refer to the same individual. The invention is particularly advantage for use with individuals with that are afflicted with a brain disorder, acquired brain injury, age-related physical or cognitive impairment, or other disorders affecting motor or cognitive functions, and individuals is afflicted with acquired brain injury caused by infection, disease, lack of oxygen, head trauma, stroke, cerebral palsy or surgery/procedure that damages the brain.

According to one embodiment of the invention, a wearable system for providing hazard alerts to a wearer comprises at least one processor coupled to a) a head mounted display (“HMD”) having a display visible to the wearer, the display adapted to enable the wearer to view at least a region of their surroundings in the direction of the wearer's gaze through said display, or rendered on the display visible to the wearer; and b) a plurality of sensors comprising at least one of image capture sensors and sensors configured to generate depth image signals, and configured to be attached to or proximate the HMD.

A corresponding method embodiment of the invention performed by the above-described system or another wearable system comprises the steps of: (i) determining a virtual volume reference outer surface for the wearer comprising at least part of a vertically-oriented virtual cylinder; (ii) determining a virtual danger zone wherein the danger zone is a vertically-oriented virtual cylinder extending a determined radial distance from the wearer's virtual reference volume outer surface to an outer surface of the virtual danger zone; (iii) determining a virtual warning zone in the form of a vertically-oriented virtual cylinder extending a determined radial distance from the danger zone outer surface to a virtual warning zone outer surface; (iv) detecting whether objects in a direction of travel of the wearer are located in the virtual warning zone or virtual danger zone; (v) transmitting hazard alert signals to the HMD to cause the HMD to generate on the display at least one of a (A) visual hazard warning image visible to the wearer, (B) an auditory hazard warning, or (C) a haptic alert, wherein the at least the visual hazard warning image indicates the object's location relative to the wearer when the object is within the virtual warning zone or virtual danger zone; and (vi) repeating steps i. through v. while the wearer is in motion.

In another embodiment, the steps of determining the virtual danger zone are based at least in part on the velocity of the wearer's motion and a predetermined value indicative of the wearer's reaction time.

In a further embodiment, the steps of determining the virtual danger zone outer surface are based at least in part on a distance of travel of the wearer based on the velocity of the wearer's motion over a predetermined time.

In yet a further embodiment, the virtual warning zone outer surface is a predetermined distance from the virtual danger zone outer surface in the range of 7 to 9 meters.

In a still further embodiment, the virtual warning zone outer surface is determined at least based in part on stored data indicative of the wearer's reaction time.

In another embodiment, a wearable system for providing hazard alerts to a wearer while moving within an environment comprises at least one processor; a HMD coupled to the at least one processor, wherein the HMD has a display visible to the wearer that is adapted to enable the wearer to view at least a region of their environment in the direction of the wearer's gaze through said display, or rendered on the display visible to the wearer; and a plurality of sensors coupled to the at least one processor, and configured to be attached to or proximate the HMD, at least one sensor of the plurality of sensors being configured to generate a depth image signals, wherein such depth image signals include information indicative of a distance from the sensor to a point in the environment. The processor of such system being configured to create disparity map data based on at least the received depth image signals; processing the disparity map data to identify different objects within the region of the wearer's environment; identifying potential objects in the disparity map data that may pose a potential hazard risk to the wearer; determining a distance of the at least one of the identified potential objects that may pose a potential hazard risk to the wearer to evaluate whether such distance is within a particular hazard distance to the wearer; and transmitting hazard signals to the HMD for the HMD to generate a hazard alert comprising a at least one (A) a visual hazard warning image visible to the wearer, (B) an auditory hazard warning, or (C) a haptic alert, wherein at least the visual hazard warning image indicates the object's location relative to the wearer when the object is within the particular hazard distance to the wearer. As used herein “disparity map data” means data indicating the disparity of apparent motion of objects occurring between a pair of stereo images, typically, taken in sequence over time. Disparity map data is typically calculated by comparing the disparities between matching pixels in two or more images of the same scene, taken from different viewpoints, such as when a person is moving, e.g., walking. The corresponding “disparity” is often the horizontal shift of pixels between the images, caused by the parallax effect, i.e., the difference in the apparent position of an object when viewed along two different lines of sight.

In an additional embodiment, at least one sensor of the plurality of sensors coupled to the at least one processor is configured to generate image capture signals indicative of the region of the wearer's surrounding. In a further embodiment, the processor is further adapted to determine a hazard type of the obstacle, and generate the hazard alert image based on the determined hazard type of the obstacle.

In another embodiment, the at least one processor is configured to further perform the method step of processing and updating the disparity map data to identify and remove a plane of the ground from said disparity map data. In another embodiment, the at least one processor's removal of the plane of the ground is based on at least one of threshold and depth constraints to determine the plain corresponding to the ground.

In yet another embodiment, the at least one processor is configured to extract pairs of matched points between consecutive images of an identified obstacle; and the at least one processor is further configured to employ such steps in determining whether at least one of the identified potential objects poses to be an obstacle within the particular hazard distance to the wearer.

In a further embodiment, the at least one processor is configured to identify potential objects that may pose a potential hazard risk to the wearer in the refined disparity map data by employing, at least in part, a connected component method.

In a still further embodiment, the at least one processor is configured to perform the step of determining a distance of the at least one of the identified potential objects to the wearer to evaluate whether such distance is within a particular hazard distance to the wearer further comprises the steps of: determining at least one outermost point of the at least one identified potential objects relative to a location of the wearer; and determining the distance between the at least one outermost point of the at least one identified potential objects to the wearer.

In another embodiment, the at least one processor is adapted to provide the hazard alert to the wearer if it determines that the object is an obstacle, which presents at least one of a tripping, banging, or other harmful hazard. In yet another embodiment, the visual hazard-warning image appears as a computer-generated, virtual image.

It is possible for the processor of the disclosed system in this disclosure to be a controlling computer and/or being controlled by a remote computer over a network. The plurality of sensors may include at least one of a stereoscopic image capture sensor, LIDAR, RADAR, and SONAR device for distance detection, and the HMD may be of type of at least one of a mixed-reality HMD, an augmented-reality HMD or virtual-reality HMD.

In yet another embodiment, the at least one processor is adapted to provide the hazard alert to the wearer of the obstacle that is located in at least one of a warning zone or a danger zone; and to receive information entered by a person, such as for example, the wearer, regarding the relative characteristics of at least one of the warning zone or danger zone. It is possible for such relative characteristics to be at least one of spatial or distance characteristics for the at least one of the warning zone or danger zone relative to a location of the wearer; and for the relative characteristics to be adjusted by at least one of warning zone or danger zone, based on at least one of the wearer's projected path of movement, moving speed, movement stability, and processing time needed by the wearer to avoid collision.

In an alternative embodiment, the at least one processer is adapted to employ preset characteristics for the adjustment of the relative characteristics of the at least one of warning zone or danger zone; and/or to employ machine learning to adjust the relative characteristics of the at least one of warning zone or danger zone based at least in part on detection of at least one of a wearer's movement characteristics or changes in such movement characteristics over time.

In another alternative embodiment, the at least one processer is adapted to perform the step of determining a most probable collision by identifying the object that is the shortest distance from the wearer based in part from at least one of a location of the object that is in a direct line of the wearers movement within the environment, and the object having a highest rate of change in reducing the distance between the wearer and such object.

### BRIEF DESCRIPTION OF THE DRAWINGS

Certain embodiments of the present invention are illustrated as an example and are not limited by the figures of the accompanying drawings, in which like references may indicate similar elements and in which:

FIG. 1 illustrates a configuration of an exemplary improved system embodiment comprising a commercially-available, virtual reality head-mounted display augmented with additional cameras and an external computing device as described with regard to various embodiments herein.

FIG. 2 illustrates a representative expanded field of view (“FOV”) achievable with the additional external cameras and computing device achieved by the embodiment of FIG. 1.

FIG. 3 depicts an illustrative example of a three-pipeline method of the embodiment of FIG. 1, for converting raw sensor data into detected obstacles with estimated distances in a system for practicing various embodiments described herein.

FIG. 4 illustrates a respective depictions of virtual danger and warning zones relative to a wearer achieved by the exemplary system embodiment of FIG. 1.

FIGS. 5 and 6 depict exemplary virtual warning signs displayable in the head mounted display of the exemplary system embodiment of FIG. 1.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It should be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software,” “software code,” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “computing device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. In some embodiments, a computing device is a smartphone or computer configured to receive and transmit data to a server or other electronic device, which may be operated locally or in the cloud. Non-limiting examples of computing devices include: personal computers (PCs), workstations, laptops, tablet PCs including the iPad, mobile phones including iOS phones made by Apple Inc., and Android OS phones, such as Samsung Galaxy phones, Blackberry phones, or any electronic device capable of running computer software and displaying information to a user, memory cards, other memory storage devices, digital cameras, external battery packs, external charging devices, and the like. Certain types of computing devices are portable and can easily carried by a person may sometimes be referred to as a “portable electronic device” or “portable device.” Some non-limiting examples of portable devices include cell phones, smartphones, tablet computers, and laptop computers.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, solid-state drives, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as computing devices either using wires or wirelessly allowing them to transmit and receive data. Non-limiting examples of data networks may include the internet or wireless networks or (i.e. a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VOIP) network.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New methods and systems for wearable assistive technology are discussed herein. In the following description, for purposes of explanation, numerous specific details are set forth in order to provide a thorough understanding of the present invention. It will be evident, however, to one skilled in the art that the present invention may be practiced without these specific details.

Early prototype that led to the invention disclosed herein, employed a readily available HoloLens 2 manufactured by Microsoft Corp. The HoloLens 2 is equipped with 4 visible-light cameras for head tracking, 2 infrared cameras for eye tracking, a 1-megapixel (MP) time-of-flight depth sensor, an 8 MP still camera, and an inertial measurement unit (IMU). A spatial mapping application-programming interface (API) by Microsoft Corp. enables use of the HoloLens cameras to detect real-world surfaces in the environment in the field of view of the HoloLens 2 to create a 3D map of the space, and localizes itself within that volume to a precision of a few centimeters.

The early prototype was programmed to scan a wearer's environment, compute the distance between the user and the obstacle, and provide alerts (stop or warning) when the obstacle is within a predefined distance. This early prototype used the spatial mapping API to map the environment of the user to detect obstacles along the moving trajectory.

The early prototype was evaluated by ten naïve older adults (over 65 years of age) and ten older adults with stroke. The participants performed standard functional metrics, 10-meter walk test (10 MWT; measuring fast walking speed), and dynamic gait index (DGI; assessing walking ability i.e., gait and dynamic balance in various ambulation tasks, such as with obstacles, stairs, etc.) in two conditions: with the prototype with visual & auditory alerts provided through the MR device and without wearing the HoloLens 2 system. The walking ability and speed did not change between the two conditions in all participants.

Although the early prototype demonstrated many advantages, the inventors of the disclosed invention identified the following the three adverse limitations of Microsoft HoloLens 2 and realized that further hardware and software engineering is needed.

Limitation 1: An insufficient FOV and thus insufficient spatial coverage for object detection by the early prototype. Mapping the indoor environment including objects within the space is crucial because falls usually occur due to collisions with objects that are unnoticed or unattended in or outside of people's visual field. To map out the entire environment, users of this prototype were required to turn their head to detect objects in the peripheral visual field as well as outside of the visual field. If users do not slowly (see Limitation 2 below) and comprehensively point the HoloLens by turning their head to every corner of the room, certain areas of the environment are unmapped and thus objects undetected. Because the FOV is equivalent to the spatial coverage of object detection, it is important that the device has an FOV that can cover at least the user's visual field and more.

Limitation 2: Slow object detection and hence delayed alert presentation by the early prototype. The spatial mapping API of the HoloLens 2 updates at the rate of 1 Hz, i.e., one update per second. The API is adequate for static tasks where HoloLens 2 can accurately scan the environment for the projection of holograms with minimal movement of users (such as when standing in place). However, the 1 Hz refresh rate is not ideal for walking. The average comfortable walking speed of individuals aged 60-69 years is 1.34 m/s in men and 1.24 m/s in women, and that of individuals aged 70-79 years is 1.26 m/s in men and 1.13 m/s in women. Thus, at the 1-Hz refresh rate, the API may detect an object and present an alert (i.e., a warning or stop sign) every 1 meter when users are walking. Users walking at a higher speed may miss warning or stop signs as the alerts may appear too late for users to react and make appropriate corrections.

Limitation 3: The early prototype is also limited by a “one-size-fits-all” approach. There is currently no customization based on user characteristics e.g., height, shoulder width, gait speed, which may affect the probability of colliding into an obstacle, such as a door or a corner of a couch.

The improved system design disclosed herein overcomes these limitations by adding hardware to a HoloLens 2, which increases the FOV (and corresponding field of detection coverage), improves processing speed by enhances computing power for near real-time usage of information with an algorithm for collision estimation that considers individual differences in physical characteristics.

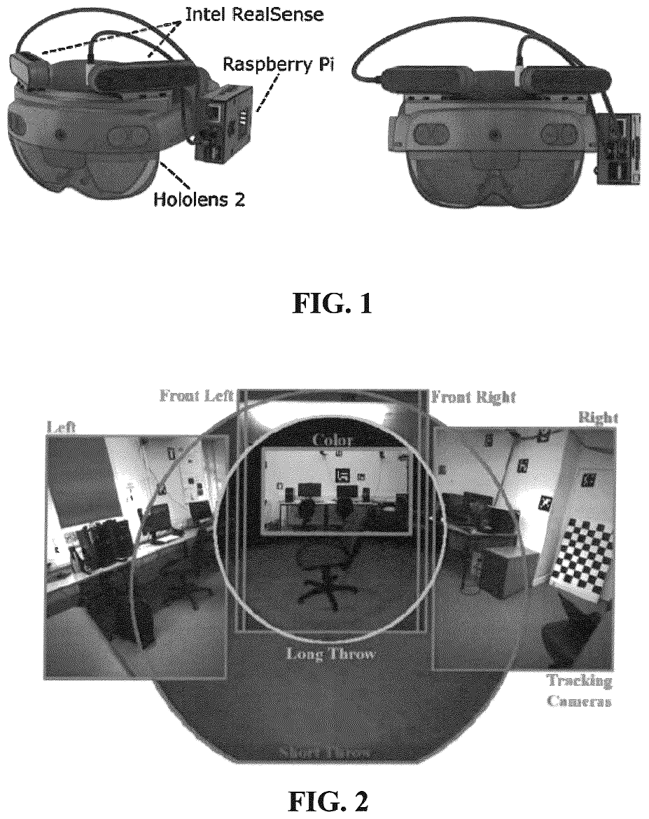

The improved system design expands the FOV and processing speed for obstacle detection during walking, relative to the early prototype. FIG. 1 depicts an exemplary embodiment of the improved system design integrates the HoloLens 2 with one or more cameras and an external computing device, such as for example, two Intel RealSense D415 RGB-D cameras and a Raspberry Pi processor, which may be mounted on the HoloLens 2 and or wearer. In such exemplary implementation, a custom mount was used for mounting the RealSense cameras and Raspberry Pi onto the HoloLens as depicted FIG. 1. In the depicted implementation in FIG. 2, the FOV of such a system may be enlarged up to 270°,by using the RealSense cameras, each having FOVs of: 65°×40° horizontal by vertical, with each cameral oriented at 45° with respect to the HoloLens 2 front-back axis. FIG. 2 depicts a representative expanded FOV with the additional external cameras and computing device.

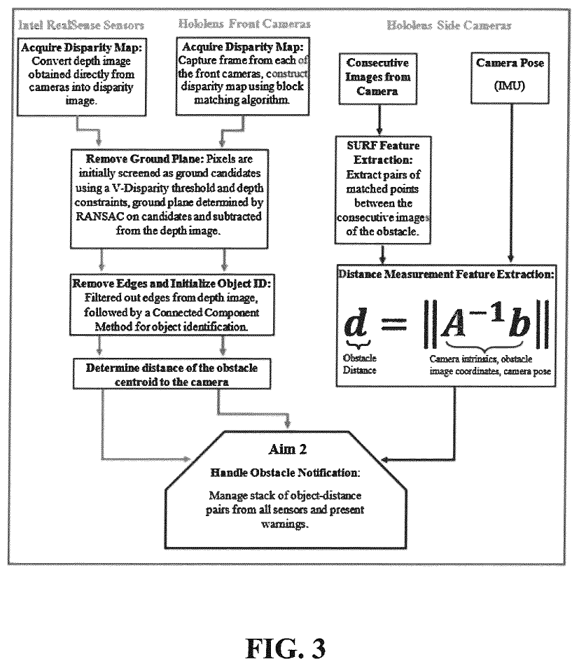

FIG. 3 depicts an exemplary method of implementing three different pipelines (referred to herein as “Pipelines 1, 2 and 3”) to convert raw sensor data, e.g., either depth data or image data, into detected obstacles with estimated distances. In FIG. 1, Pipeline 1 is produced by a vision processor contained within the RealSense cameras, which deliver depth image frames (also, referred to herein as a “depth frame”) to the Raspberry Pi, such as a Raspberry Pi Model 4b+, in real time at up to 90 frames a second. Each depth frame will be acquired on the Raspberry Pi using a cross-platform software development kit, such as for example, LibRealSense offered by Intel Corp. and available at github.com/IntelRealSense/librealsense. The Raspberry PI processes the received depth frames to reduce excess resolution and patch holes in the depth image. Other processors may be used for the external computing device as long as such processors have adequate processing speeds, including for example, the Jetson Nano available from NVIDIA Inc.

In operation, sensor generated depth images are converted into a U-V-disparity image in real time to begin the obstacle detection and distance estimation procedure. To minimize the computational time dedicated to the subsequent steps of obstacle detection, advantageous strategies are employed to reduce the feasible search region, along with simple object labelling techniques. To prevent needless obstacle searching within the traversable area, it is beneficial to separate or remove the ground, e.g., floor, from the relevant scene in a depth image.

One exemplary process for such removal is by using the V component of the disparity image, as described by Huang H. C., Hsich, C. T., & Ych, C. H. (2015). An indoor obstacle detection system using depth information and region growth. Sensors, 15(10), 27116-27141, available at www.doi.org/10.3390/s151027116. Specifically, the boundaries of the ground appear as a sharp rising curve emerging from the bottom of the V disparity map, and can be captured using simple quadratic polynomials. The points on this polynomial can be used to estimate where the ground is in depth-space, and from there the ground plane can be located using a depth threshold criterion alongside a region-fitting method (e.g., RANSAC).

Once the ground plane is segmented and removed, the remaining edges are removed from the depth image using an edge-removing image filter, which generates a contrast between object and the rest of the environment. With this edge-removed depth image, an 8-connected component labeling method (CCM) may be applied to identify obstacles. To speed up this method, the CCM may use a reference template to initialize the algorithm at points near edges (since the edges have been removed prior to this step, points near the edges can be efficiently detected by the template). The user-object distance is then determined from the detected object. It should be readily understood by skilled artisans that other processes and techniques may be employed for removing the ground, from the relevant scene in a depth image.

Pipeline 2 employs an identical object detection process for both of the two front-facing visible light cameras of the HoloLens 2, which are oriented for stereoscopic vision. However, the HoloLens 2 does not provide a depth map for application development. In order to create such a depth map, the raw image frames from the front cameras are transmitted from the HoloLens 2 to the Raspberry Pi through, for example, a standard user datagram protocol (UDP) over a USB-C-to-Ethernet connection, and the depth image may be created, for example, using a block-matching algorithm included in, for example, the OpenCV computer vision library, which is an open source software program library available at www.opencv.org.

Pipeline 3 utilizes the side cameras of the HoloLens 2 in a monocular setup for obstacle detection. In one exemplary manner, the obstacle detection may be accomplished by using consecutive frames from each camera, respectively. An object's location in world coordinates can then be determined if the following information is known: 1) the object's location in image-space from two consecutive frames, 2) the position and orientation of the camera in world coordinates (i.e., camera pose), and 3) the intrinsic properties of the camera, i.e., the optical center, focal length and optionally, distortions, of the camera lens, whereby the world points are transformed to camera coordinates using the extrinsic parameters. The camera coordinates are mapped into the image plane using the intrinsic parameters. With the above information, the distance can be estimated using the exemplary method disclosed in Saha, S., Natraj, A., & Waharte, S. (2014). A real-time monocular vision-based frontal obstacle detection and avoidance for low cost UAVs in GPS denied environment. IEEE International Conference on Aerospace Electronics and Remote Sensing Technology, 189-195. www.doi.org/10.1109/ICARES.2014.7024382 to processes each frame may be processed through a speeded up robust features (SURF) algorithm to locate key points of the objects in the scene [22]. An exemplary brute-force algorithm may then be used to match key points from each obstacle between frames, such as for example, the brute-force algorithm described in Al-Kaff, A., Garcia, F., Martin, D., De La Escalera, A., & Armingol, J. M. (2017). Obstacle detection and avoidance system based on monocular camera and size expansion algorithm for UAVs. Sensors, 17(5), available at www.doi.org/10.3390/s17051061

The convex hull of key points that corresponds with a given object may be determined by using, for example, the applicable routine in the OpenCV software library, and the center of the hull in image-space may be determined for the two consecutive frames. The camera pose may be determined using the IMU sensor of the HoloLens with an extended Kalman filter [23]. Lastly, the camera's intrinsic properties may be used for calibrating the system using, for example, an applicable calibration procedure in the OpenCV software library.

Implementation of the three pipelines as described above with regard to FIG. 3 may enlarge the FOV the complete system up to 270°, covering the entire volume within the FOV (unlike the total FOV of the HoloLens 2 alone depicted in FIG. 1). These pipelines may send the detected obstacles and their corresponding distances to a receiving program that handles the display of alerts to the user with the support of a high Raspberry Pi, depicted in FIG. 1, operating speeds of up to 30 Hz.

In order to perform a collision estimation, the improved system relies on certain information regarding the wearer, which may be provided by creating a profile in the system for such wearer containing information of, for example, physical characteristics (height and shoulder width) of the person, reaction time, and walking speed. The reaction time and walking speed may be entered in to the system or may be obtained through automated means.

In an exemplary automated process for determining the wearer's average walking speed, the wearer may be presented with the written and/or voiced-over instructions to start walking at a comfortable speed on go, with the system calculating the walking speed after the wearer walks a threshold distance, e.g., approximately 6 meters. The corresponding HoloLens 2 accelerometer values could then be converted to position values by, for example, integrating the acceleration values twice. The difference in position between the current frame when the wearer starts walking frame may be used to determine if the user has moved 6 meters. If so, the wearer may be instructed to stop walking in at least one of written and verbal cue. The speed could then be computed by using the time taken to walk the 6-meter distance.

In an exemplary automated process for determining the reaction time, the user may be presented with the written and/or voiced-over instructions to alert the use to tap the viewing screen upon a change in the display, e.g., tap the screen when its display changes from one color to another color, such as from red to green. The monitored time taken to tap since the onset of the green screen is recorded. This task may be repeated multiple times of for example, at least three times. The average time taken to perform the task could then be recorded as reaction time.

Different techniques may be used for determining a probability of collision based on the user information and distance of the obstacles. In accordance with one exemplary technique, a unity user object, i.e., virtual cylinder (invisible to users) may be created with user's height and width using, for example, Unity3D game engine software available from Unity Technologies Corporation. The collision distance to objects in the real world may be computed using the distance of the camera and the unity user object. The user-object distance may be stored for 4 consecutive frames.

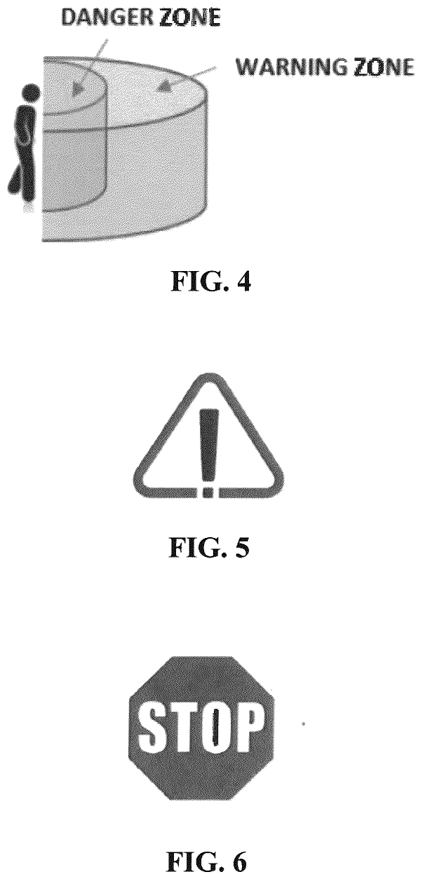

FIG. 4 depicts representative virtual danger and warning zones, which may be personalized to the wearer based on, for example, at least the stored walking speed and reaction time. The reason for considering user walking speed and reaction time in the calculation of the collision detection is that each person processes information and respond at different rates, so it is critical that the timing of alert presentation is personalized to each user so that they have sufficient time to respond and avoid an obstacle.

Different techniques may be employed to determine the danger and warning zones. In one exemplary implementation, the danger zone may be determined as: (walking speed×1 sec)+(1 meter for every 0.1 sec reaction time over 300 msec), up to a predetermined distance, e.g., 4 meters, covering 270° of the user's frontal plane. The distance of a predetermined distance, e.g., 8 meters beyond the danger zone and may be regarded as the warning zone. In the exemplary danger-zone calculation, approximately 300 msec may be used as the minimum threshold for adding more distance based on the classic stimulus-response literature on humans' simple reaction to a stimulus with no required response selection. Distances of up to 4 and 8 meters to provide warning and danger alerts based on past experience. However, an alternative method for determining dynamic distances from a wearer for the danger and warning zones may be based on, for example, machine learning algorithms. The ranges of warning and danger zones may alternatively be computed once and stored in the user profile.

Determining Most Probable Collision: The three respective pipelines of FIG. 3 operate independently of one another. As a result, it is possible that the same object may be detected by multiple sensors. In order to manage the potential overlap of received data for the same object, the system uses a simple distance threshold to determine if the same object is detected in the multiple pipelines. For example, in a representative implementation, when an object is detected at a certain distance through one pipeline, a threshold may be set to that distance to see if objects from other pipelines match the threshold. If so, they are considered to be the same object. Multiple objects may also be detected in any given frame from all cameras. In order to provide sufficient information without overwhelming the user, the system computes a most probable collision.

In order to perform this computation, the rate of change of user-obstacle distance (i.e., considering the speed of the obstacle and user), and direction of user movement are critical. The most probable collision is computed as the object with the shortest distance from the user, in a direct line of collision, and with the highest rate of change of user-obstacle distance. All such computations may advantageously be performed by the external computing device. One exemplary method for computing the rate of change of user-obstacle distance is to compare the user-obstacle distance between consecutive frames. The rate of change may be computed as the difference between distances between frames divided by time.

Direction of User Movement: The HoloLens IMU data may be used to determine the direction of user movement and line of collision with an obstacle (i.e., straight, unobscured trajectory toward a direct contact between the user and obstacle).

The system provides auditory, visual, and/or haptic alerts in near real-time based on the probability of collision. Exemplary warning and stop alerts may be presented when an obstacle enters the warning and danger zones, respectively, when (1) either of these two conditions are met; (2) the user is moving, and (3) the obstacle is determined as the most probable collision. No alerts may be presented when no horizontal movement of the user is detected. Based on a user's selected preferences, the generated exemplary warning visual graphics, sound effects and/or haptic patterns are presented as alerts based on the computed probability of collision. visual or/and auditory alerts may be presented. Suitable visual alerts include those depicted in FIGS. 5 and 6.

In certain embodiments, a personalized experience can be achieved by enabling customization by allowing users to choose from a set of pre-programmed visual, sound effects and/or haptic vibration pattern, or to modify such alerts.

It is believed that at least a 30 Hz operating speed image frame speed is sufficient based on the typical walking speed during community ambulation, which is slightly faster than 1 m/s in older adults as reported in, for example, Bohannon, R. W., & Williams Andrews, A. (2011). Normal Walking Speed: A Descriptive Meta-Analysis. Physiotherapy, 97(3), 182-189, available at www.doi.org/10.1016/j.physio.2010.12.004. Therefore, detecting obstacles at 30 Hz and thus providing alerts at 30 frames/s when obstacles appear in the warning zone should be sufficient for the user to change their course of walking, or to stop walking when the obstacle enters the danger zone.

It is advantageous, when the system detects that an object is within the warning or danger zone and in the direction of the wearer's movement, and when the object is the most probable collision, the user may be notified with the generated virtual visual alerts appearing with pointers and signs proximate the object based on the position and location target of the wearer's gaze.

Several embodiments of the invention have been described herein with two alert zones, i.e., the warning and danger zones, for illustrative purposes. However, it should be readily understood that other embodiments of the invention may be implemented with a single alert zone, or three or more alert zones for providing alerts to the user. Further, the number of zones may be dynamically determined based on the type of objects identified by the system and their associated different potential hazard levels.

The present disclosure is to be considered as an exemplification of the invention, and is not intended to limit the invention to the specific embodiments illustrated by the figures or description below.

The software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost. For example, the external computing device may be implemented in a computer server accessible over a network by the HMD or other component of the improved system.

The invention is further described by the following numbered paragraphs:

1. A wearable system for providing hazard alerts to a wearer while moving within an environment, the system comprising:
a) at least one processor;
b) a head mounted display (“HMD”) coupled to the at least one processor, said HMD having a display visible to the wearer, the display adapted to enable the wearer to view at least a region of their environment in the direction of the wearer's gaze through said display, or rendered on the display visible to the wearer; and
c) a plurality of sensors coupled to the at least one processor, and configured to be attached to or proximate the HMD, at least one sensor of the plurality of sensors being configured to generate a depth image signals, wherein such depth image signals include information indicative of a distance from the sensor to a point in the environment; and
d) said at least one processor configured to receive the depth image signals and perform the steps of:
   i) creating disparity map data based on at least the received depth image signals,
   ii) processing the disparity map data to identify different objects within the region of the wearer's environment;
   iii) identifying potential objects in the disparity map data that may pose a potential hazard risk to the wearer;
   iv) determining a distance of the at least one of the identified potential objects that may pose a potential hazard risk to the wearer to evaluate whether such distance is within a particular hazard distance to the wearer, and
   v) transmitting hazard signals to the HMD for the HMD to generate a hazard alert comprising a at least one (A) a visual hazard warning image visible to the wearer, (B) an auditory hazard warning, or (C) a haptic alert, wherein the at least the visual hazard warning image indicates the object's location relative to the wearer when the object is within the particular hazard distance to the wearer.

2. The system of paragraph 1, wherein the plurality of sensors coupled to the at least one processor further comprises at least one sensor of the plurality of sensors being configured to generate image capture signals indicative of the region of the wearer's surrounding.

3. The system of paragraph 1, wherein the processor is further adapted to determine a hazard type of the obstacle, and generate the hazard alert image based on the determined hazard type of the obstacle.

4. The system of paragraph 1, wherein the at least one processor is configured to further per-form the method step of processing and updating the disparity map data to at least one of identify and remove a plane of the ground from said disparity map data.

5. The system of paragraph 4, wherein the at least one processor's removal of the plane of the ground to produce refined disparity map data is based on at least one of threshold and depth constraints to determine the plain corresponding to the ground.

6. The system of paragraph 1, wherein the at least one processor is configured to extract pairs of matched points between consecutive images of an identified obstacle; and the at least one processor is further configured to employ such steps in determining whether at least one of the identified potential objects poses to be an obstacle within the particular hazard distance to the wearer.

7. The system of paragraph 1, wherein the at least one processor is configured to identifying potential objects that may pose a potential hazard risk to the wearer in the refined dis-parity map data by employing at least in part a connected component method.

8. The system of paragraph 1, wherein the at least one processor is configured to perform the step of determining a distance of the at least one of the identified potential objects to the wearer to evaluate whether such distance is within a particular hazard distance to the wearer further comprises the steps of:
determining at least one outermost point of the at least one identified potential objects relative to a location of the wearer; and
determining the distance between the at least one outermost point of the at least one identified potential objects to the wearer.

9. The system of paragraph 1, wherein the at least one processer is adapted provide the hazard alert to the wearer if it determines that the object is an obstacle, which presents at least one of a tripping, banging, or other harmful hazard.

10. The system of paragraph 1, wherein the visual hazard-warning image appears as a computer-generated, virtual image.

11. The system of paragraph 1, wherein the processor is a controlling computer and/or being controlled by a remote computer over a network.

12. The system of paragraph 1, wherein the plurality of sensors include at least one of a stereoscopic image capture sensor, LIDAR, RADAR, and SONAR device for distance detection.

13. The system of paragraph 1, wherein the HMD is at least one of a mixed-reality HMD, an augmented-reality HMD or virtual-reality HMD.

14. The system of paragraph 1, wherein the at least one processer is configured to provide the hazard alert to the wearer of the obstacle that is located in at least one of a warning zone or a danger zone.

15. The system of paragraph 14, wherein the at least one processer is adapted to receive information entered by a person regarding the relative characteristics of at least one of the warning zone or danger zone.

16. The system of paragraph 15, wherein the person is the wearer.

17. The system of paragraph 15, wherein the at least one processer is adapted to receive the relative characteristics is at least one of spatial or distance characteristics for the at least one of the warning zone or danger zone relative to a location of the wearer.

18. The system of paragraph 15, wherein the at least one processer is adapted to adjust the relative characteristics of the at least one of warning zone or danger zone, based on at least one of the wearer's projected path of movement, moving speed, movement stability, and processing time needed by the wearer to avoid collision.

19. The system of paragraph 15, wherein the at least one processer is adapted to employ preset characteristics for the adjustment of the relative characteristics of the at least one of warning zone or danger zone.

20. The system of paragraph 15, wherein the at least one processer is adapted to employ machine learning to adjust the relative characteristics of the at least one of warning zone or danger zone based at least in part on detection of at least one of a wearer's movement characteristics or changes in such movement characteristics over time.

21. The system of paragraph 15, wherein the processor is further adapted to perform the step of determining a most probable collision by identifying the object that is the shortest distance from the wearer based in part from at least one of a location of the object that is in a direct line of the wearers movement within the environment, and the object having a highest rate of change in reducing the distance between the wearer and such object.

22. The system of paragraph 1, wherein the system is adapted for use by a wearer that is afflicted with a brain disorder, acquired brain injury, age-related physical or cognitive impairment, or other disorders affecting motor or cognitive functions.

23. The system of paragraph 22, wherein the wearer is afflicted with acquired brain injury caused by infection, disease, lack of oxygen, head trauma, stroke, cerebral palsy or surgery/procedure that damages the brain.

24. A wearable system for providing hazard alerts to a wearer moving within an environment, the system comprising:
a) at least one processor;
b) a head mounted display (“HMD”) coupled to the at least one processor, said HMD having a display visible to the wearer, the display adapted to enable the wearer to view at least a region of their surroundings in the direction of the wearer's gaze through said display, or rendered on such region on the display visible to the wearer; and
c) a plurality of sensors coupled to the at least one processor, and configured to be attached to or proximate the HMD, at least one sensor of the plurality of sensors being configured to generate a depth image signals, wherein such depth image signals include information indicative of a distance from the sensor to a point in the environment, and at least one other sensor of the plurality of sensors being configured to generate image capture signals indicative of the region of the wearer's surrounding; and
d) said at least one processor configured to receive the depth image signals and image capture signals and perform the steps of:
   i. determining a virtual volume reference outer surface of the wearer comprising at least part of a vertically-oriented virtual cylinder at a radial distance from a vertical centroid of the wearer;
   ii. determining a virtual danger zone wherein the danger zone is a vertically-oriented virtual cylinder extending a determined radial distance from the wearer's virtual reference volume outer surface to an outer surface of the virtual danger zone;
   iii. determining a virtual warning zone in the form of a vertically-oriented virtual cylinder extending a determined radial distance from the danger zone outer sur-face to a virtual warning zone outer surface;
   iv. detecting whether objects in a direction of travel of the wearer are located in the virtual warning zone or virtual danger zone;
   v. transmit hazard alert signals to the HMD to cause the HMD to generate at least one of a (A) a visual hazard warning image visible to the wearer, (B) an auditory hazard warning, or (C) a haptic alert, wherein the at least the visual hazard warning image indicates the object's location relative to the wearer when the object is within virtual warning zone or virtual danger zone; and
   vi. repeating steps b through e while the wearer is in motion.

25. A method for a wearable system for providing hazard alerts to a wearer, the wearable system comprising at least one processor coupled to a) a head mounted display (“HMD”) having a display visible to the wearer, the display adapted to enable the wearer to view at least a region of their surroundings in the direction of the wearer's gaze through said display, or rendered on the display visible to the wearer; and b) a plurality of sensors comprising at least one of image capture sensors and sensors configured to generate depth image signals, and configured to be attached to or proximate the HMD, the method comprising the steps of:
i. determining a virtual volume reference outer surface of the wearer comprising at least part of a vertically-oriented virtual cylinder;
ii. determining a virtual danger zone wherein the danger zone is a vertically-oriented virtual cylinder extending a determined radial distance from the wearer's virtual reference volume outer surface to an outer surface of the virtual danger zone;
iii. determining a virtual warning zone in the form of a vertically-oriented virtual cylinder extending a determined radial distance from the danger zone outer sur-face to a virtual warning zone outer surface;
iv. detecting whether objects in a direction of travel of the wearer are located in the virtual warning zone or virtual danger zone;
v. transmit hazard alert signals to the HMD to cause the HMD generates on the display at least one of a (A) visual hazard warning image visible to the wearer, (B) an auditory hazard warning, or (C) a haptic alert, wherein the at least the visual hazard warning image indicates the object's location relative to the wearer when the object is within the virtual warning zone or virtual danger zone; and
vi. repeating steps i. through v. while the wearer is in motion.

26. The method of paragraph 25, wherein the steps of determining the virtual danger zone is based at least in part on the velocity of the wear's motion and a predetermined value indicative of the wearer's reaction time.

27. The method of paragraph 25, wherein the steps of determining the virtual danger zone outer surface is based at least in part on a distance of travel of the wearer based on the velocity of the wearer's motion over a predetermined time.

28. The method of paragraph 25 wherein the virtual warning zone outer surface is a predetermined distance from the virtual danger zone outer surface in the range of 7 to 9 meters.

29. The method of claim 25 wherein the virtual warning zone outer surface is determined at least based in part on stored data indicative of the wearer's reaction time.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A wearable system for providing hazard alerts to a wearer while moving within an environment, the system comprising:
a) at least one processor;
b) a head mounted display (“HMD”) coupled to the at least one processor, said HMD having a display visible to the wearer, the display adapted to enable the wearer to view at least a region of their environment in the direction of the wearer's gaze through said display, or rendered on the display visible to the wearer; and
c) a plurality of sensors coupled to the at least one processor, and configured to be attached to or proximate the HMD, at least one sensor of the plurality of sensors being configured to generate a depth image signals, wherein such depth image signals include information indicative of a distance from the sensor to a point in the environment; and
d) said at least one processor configured to receive the depth image signals and per-form the steps of:
i) creating disparity map data based on at least the received depth image signals,
ii) processing the disparity map data to identify different objects within the region of the wearer's environment;
iii) identifying potential objects in the disparity map data that may pose a potential hazard risk to the wearer;
iv) determining a distance of the at least one of the identified potential objects that may pose a potential hazard risk to the wearer to evaluate whether such distance is within a particular hazard distance to the wearer, and
v) transmitting hazard signals to the HMD for the HMD to generate a hazard alert comprising a at least one (A) a visual hazard warning image visible to the wearer, (B) an auditory hazard warning, or (C) a haptic alert, wherein the at least the visual hazard warning image indicates the object's location relative to the wearer when the object is within the particular hazard distance to the wearer.

2. The system of claim 1, wherein the plurality of sensors coupled to the at least one processor further comprises at least one sensor of the plurality of sensors being configured to generate image capture signals indicative of the region of the wearer's surrounding.

3. The system of claim 1, wherein the processor is further adapted to determine a hazard type of the obstacle, and generate the hazard alert image based on the determined hazard type of the obstacle.

4. The system of claim 1, wherein the at least one processor is configured to further per-form the method step of processing and updating the disparity map data to at least one of identify and remove a plane of the ground from said disparity map data.

5. The system of claim 4, wherein the at least one processor's removal of the plane of the ground to produce refined disparity map data is based on at least one of threshold and depth constraints to determine the plain corresponding to the ground.

6. The system of claim 1, wherein the at least one processor is configured to extract pairs of matched points between consecutive images of an identified obstacle; and the at least one processor is further configured to employ such steps in determining whether at least one of the identified potential objects poses to be an obstacle within the particular hazard distance to the wearer.

7. The system of claim 1, wherein the at least one processor is configured to identifying potential objects that may pose a potential hazard risk to the wearer in the refined dis-parity map data by employing at least in part a connected component method.

8. The system of claim 1, wherein the at least one processor is configured to perform the step of determining a distance of the at least one of the identified potential objects to the wearer to evaluate whether such distance is within a particular hazard distance to the wearer further comprises the steps of:
determining at least one outermost point of the at least one identified potential objects relative to a location of the wearer; and
determining the distance between the at least one outermost point of the at least one identified potential objects to the wearer.

9. The system of claim 1, wherein the at least one processer is adapted provide the hazard alert to the wearer if it determines that the object is an obstacle, which presents at least one of a tripping, banging, or other harmful hazard.

10. The system of claim 1, wherein the visual hazard-warning image appears as a computer-generated, virtual image.

11. The system of claim 1, wherein the processor is a controlling computer and/or being controlled by a remote computer over a network.

12. The system of claim 1, wherein the plurality of sensors include at least one of a stereoscopic image capture sensor, LIDAR, RADAR, and SONAR device for distance detection.

13. The system of claim 1, wherein the HMD is at least one of a mixed-reality HMD, an augmented-reality HMD or virtual-reality HMD.

14. The system of claim 1, wherein the at least one processer is configured to provide the hazard alert to the wearer of the obstacle that is located in at least one of a warning zone or a danger zone.

15. The system of claim 14, wherein the at least one processer is adapted to receive information entered by a person regarding the relative characteristics of at least one of the warning zone or danger zone.

16. The system of claim 15, wherein the person is the wearer.

17. The system of claim 15, wherein the at least one processer is adapted to receive the relative characteristics is at least one of spatial or distance characteristics for the at least one of the warning zone or danger zone relative to a location of the wearer.

18. The system of claim 15, wherein the at least one processer is adapted to adjust the relative characteristics of the at least one of warning zone or danger zone, based on at least one of the wearer's projected path of movement, moving speed, movement stability, and processing time needed by the wearer to avoid collision.

19. The system of claim 15, wherein the at least one processer is adapted to employ preset characteristics for the adjustment of the relative characteristics of the at least one of warning zone or danger zone.

20. The system of claim 15, wherein the at least one processer is adapted to employ machine learning to adjust the relative characteristics of the at least one of warning zone or danger zone based at least in part on detection of at least one of a wearer's movement characteristics or changes in such movement characteristics over time.

21. The system of claim 15, wherein the processor is further adapted to perform the step of determining a most probable collision by identifying the object that is the shortest distance from the wearer based in part from at least one of a location of the object that is in a direct line of the wearers movement within the environment, and the object having a highest rate of change in reducing the distance between the wearer and such object.

22. The system of claim 1, wherein the system is adapted for use by a wearer that is afflicted with a brain disorder, acquired brain injury, age-related physical or cognitive impairment, or other disorders affecting motor or cognitive functions.

23. The system of claim 22, wherein the wearer is afflicted with acquired brain injury caused by infection, disease, lack of oxygen, head trauma, stroke, cerebral palsy or surgery/procedure that damages the brain.

24. A wearable system for providing hazard alerts to a wearer moving within an environment, the system comprising:
a) at least one processor;
b) a head mounted display (“HMD”) coupled to the at least one processor, said HMD having a display visible to the wearer, the display adapted to enable the wearer to view at least a region of their surroundings in the direction of the wearer's gaze through said display, or rendered on such region on the display visible to the wearer; and
c) a plurality of sensors coupled to the at least one processor, and configured to be attached to or proximate the HMD, at least one sensor of the plurality of sensors being configured to generate a depth image signals, wherein such depth image signals include information indicative of a distance from the sensor to a point in the environment, and at least one other sensor of the plurality of sensors being configured to generate image capture signals indicative of the region of the wearer's surrounding; and
d) said at least one processor configured to receive the depth image signals and image capture signals and perform the steps of:
i. determining a virtual volume reference outer surface of the wearer comprising at least part of a vertically-oriented virtual cylinder at a radial distance from a vertical centroid of the wearer;
ii. determining a virtual danger zone wherein the danger zone is a vertically-oriented virtual cylinder extending a determined radial distance from the wearer's virtual reference volume outer surface to an outer surface of the virtual danger zone;
iii. determining a virtual warning zone in the form of a vertically-oriented virtual cylinder extending a determined radial distance from the danger zone outer sur-face to a virtual warning zone outer surface;
iv. detecting whether objects in a direction of travel of the wearer are located in the virtual warning zone or virtual danger zone;
v. transmit hazard alert signals to the HMD to cause the HMD to generate at least one of a (A) a visual hazard warning image visible to the wearer, (B) an auditory hazard warning, or (C) a haptic alert, wherein the at least the visual hazard warning image indicates the object's location relative to the wearer when the object is within virtual warning zone or virtual danger zone; and
vi. repeating steps b through e while the wearer is in motion.

25. A method for a wearable system for providing hazard alerts to a wearer, the wearable system comprising at least one processor coupled to a) a head mounted display (“HMD”) having a display visible to the wearer, the display adapted to enable the wearer to view at least a region of their surroundings in the direction of the wearer's gaze through said display, or rendered on the display visible to the wearer; and b) a plurality of sensors comprising at least one of image capture sensors and sensors configured to generate depth image signals, and configured to be attached to or proximate the HMD, the method comprising the steps of:
i. determining a virtual volume reference outer surface of the wearer comprising at least part of a vertically-oriented virtual cylinder;
ii. determining a virtual danger zone wherein the danger zone is a vertically-oriented virtual cylinder extending a determined radial distance from the wearer's virtual reference volume outer surface to an outer surface of the virtual danger zone;
iii. determining a virtual warning zone in the form of a vertically-oriented virtual cylinder extending a determined radial distance from the danger zone outer sur-face to a virtual warning zone outer surface;
iv. detecting whether objects in a direction of travel of the wearer are located in the virtual warning zone or virtual danger zone;
v. transmit hazard alert signals to the HMD to cause the HMD generates on the display at least one of a (A) visual hazard warning image visible to the wearer, (B) an auditory hazard warning, or (C) a haptic alert, wherein the at least the visual hazard warning image indicates the object's location relative to the wearer when the object is within the virtual warning zone or virtual danger zone; and
vi. repeating steps i. through v. while the wearer is in motion.

26. The method of claim 25, wherein the steps of determining the virtual danger zone is based at least in part on the velocity of the wear's motion and a predetermined value indicative of the wearer's reaction time.

27. The method of claim 25, wherein the steps of determining the virtual danger zone outer surface is based at least in part on a distance of travel of the wearer based on the velocity of the wearer's motion over a predetermined time.

28. The method of claim 25 wherein the virtual warning zone outer surface is a predetermined distance from the virtual danger zone outer surface in the range of 7 to 9 meters.

29. The method of claim 25 wherein the virtual warning zone outer surface is determined at least based in part on stored data indicative of the wearer's reaction time.
